(19) United States
(12) Patent Application Publication
(10) Pub. No.: US 2019/0048784 A1
(43) Pub. Date: Feb. 14, 2019

(54) INTERNAL COMBUSION ENGINE

(71) Applicant: TOYOTA JIDOSHA KABUSHIKI KAISHA, Toyota-shi (JP)

(72) Inventor: Takeshi ASHIZAWA, Yokohama-shi (JP)

(73) Assignee: TOYOTA JIDOSHA KABUSHIKI KAISHA, Toyota-shi (JP)

(21) Appl. No.: 16/058,345

(22) Filed: Aug. 8, 2018

(30) Foreign Application Priority Data
Aug. 9, 2017 (JP) 2017-154544

(51) Int. Cl. F02B 19/18; F02B 19/10

(52) U.S. Cl. CPC F02B 19/18; F02B 19/108; F02B 19/1023

(57) ABSTRACT

An internal combustion engine 10 comprises a spark plug 70 which has a spark generation part 71, and a partition wall part 80. The partition wall part 80 partitions a combustion chamber CC into a main combustion chamber CM and an ignition chamber CI. The combustion chamber is defined by a cylinder bore wall 21, a piston crown surface part 31 and a cylinder head wall 41. The cylinder bore wall and the piston crown surface part are exposed to the main combustion chamber, and the spark generation part is exposed to the ignition chamber. “A through hole 81 and a through hole 82” are formed in the partition wall part such that the main combustion chamber and the ignition chamber are in communication with each other. Flame is generated in the ignition chamber when combustion of fuel-air mixture is started by a spark generated from the spark generation part in the ignition chamber. The flame is ejected from the ignition chamber into the main combustion chamber through the first and second through holes. Distance between the first through hole and the cylinder bore wall is longer than distance between the second through hole and the cylinder bore wall. The first and second through holes are formed such that penetration of the flame ejected from the first through hole is larger than penetration of the flame ejected from the second through hole.

### TECHNICAL FIELD

The present invention relates to an internal combustion engine configured to generate flame in an ignition chamber, to which a spark plug is exposed, and inject the flame from the ignition chamber to a main combustion chamber.

### BACKGROUND ART

In one of internal combustion engines known conventionally (which may be referred to as a “conventional engine” hereafter), an ignition chamber, in which combustion of fuel-air mixture is started by a spark generated by a spark plug, is formed in a combustion chamber with a plug cover which covers an ignition point (spark generation part) of the spark plug. The region other than the ignition chamber in the combustion chamber may be referred to as a “main combustion chamber” for convenience. The conventional engine is configured to eject (spout) the fuel-air mixture which has started combustion in the ignition chamber (namely, flame or gas under combustion) from the ignition chamber into the main combustion chamber through a plurality of through holes formed in the plug cover.

On the other hand, when an ignition chamber cannot be prepared in the center of the upper part of a combustion chamber due to the arrangement position of an intake valve and an exhaust valve, etc., with respect to the combustion chambers, distances between respective ones of a plurality of the through holes formed in the plug cover and a wall of the combustion chamber become unequal among the plurality of the through holes. Therefore, in the conventional engine, the plug cover is formed such that the bore (hole diameter) of the through hole which ejects flame to a region where the above-mentioned distance is long is larger than the bore of the through hole which ejects flame to a region where the above-mentioned distance is short. It is thought that flame can be supplied over the whole main combustion chamber as a result of this (for example, refer to the Patent Document 1 (PTL1)).

### CITATION LIST

### Patent Literature

[PTL1] Japanese Patent Application Laid-Open (kokai) No. 2009-270538 (Paragraphs 0010 and 0032, and FIG. 2)

### SUMMARY OF INVENTION

However, in the conventional engine, since the bore of the through hole, through which flame is ejected to the region where the above-mentioned distance is long, is large, the penetration of the flame ejected from the through hole is small and there is a possibility that the flame may be unable to reach the vicinity of the wall of the combustion chamber (cylinder bore wall). When the flame cannot reach the vicinity of the wall of the combustion chamber, there are problems such as unstable combustion of fuel-air mixture remaining in a region where flame cannot reach becomes unstable and/or an occurrence of knocking due to self ignition of the fuel-air mixture in the region.

The present invention has been made in order to cope with such problems. Namely, one objective of the present invention is to stabilize combustion of fuel-air mixture in a main combustion chamber in an internal combustion engine which ejects flame from an ignition chamber into the main combustion chamber.

An internal combustion engine according to the present invention (which may be referred to as a “present invention engine” hereafter) is an internal combustion engine comprising:

a spark plug (70, 70a) which has a spark generation part (71, 71a), and

a partition wall part (80, 90 and 130 etc.) which partitions a combustion chamber (CC) into a main combustion chamber (CM) and an ignition chamber (CI), the combustion chamber is defined by a cylinder bore wall (21), a piston crown surface part (31) and a cylinder head wall (41), the cylinder bore wall and the piston crown surface part are exposed to the main combustion chamber, the spark generation part is exposed to the ignition chamber, and a plurality of through holes are formed in the partition wall part such that the main combustion chamber and the ignition chamber are in communication with each other, and

the internal combustion engine is configured such that flame is generated by initiating combustion of fuel-air mixture with a spark generated from the spark generation part in the ignition chamber and the flame is ejected from the ignition chamber to the main combustion chamber through the plurality of the through holes.

The plurality of the through holes in the partition wall part (80, 90 and 130 etc.) includes a first through hole (81, 91, 131) and a second through hole (82, 92, 132),

a distance between a first opening (81k, 91k, 131k) that is an end of the first through hole on a side of the main combustion chamber and a region of the cylinder bore wall, which is opposed to the first opening, is equal to a first distance (M1, M1a, M1b),

a distance between a second opening (82k, 92k, 132k) that is an end of the second through hole on a side of the main combustion chamber and a region of the cylinder bore wall, which is opposed to the second opening, is equal to a “second distance (M2, M2a, M2b) which is shorter than the first distance”, and

the first through hole and the second through hole are formed such that penetration of the flame ejected from the first through hole is larger (stronger) than penetration of the flame ejected from the second through hole.

Accordingly, in accordance with the present invention engine, the penetration of the flame (F1, F1a) ejected from the through hole with a longer “distance between the opening of the through hole and the region of the cylinder bore wall, which is opposed to the opening” (first through hole) is larger than the penetration of the flame (F2, F2a) ejected from the through hole with a shorter “distance between the opening of the through hole and the region of the cylinder bore wall, which is opposed to the opening” (second through hole). Therefore, it is possible for the flame ejected from the first through hole to reach the vicinity of the cylinder bore wall, without the flame ejected from the second through hole colliding with the cylinder bore wall strongly more than needed. As a result, by the flame ejected from the ignition chamber, fuel-air mixture can be burned stably in the main combustion chamber.

In one aspect of the present invention engine,

the first through hole (81) is in the shape of a cylinder whose cross-section intersecting perpendicularly to an axis direction of the cylinder has a first diameter (D1) and whose length in the axis direction is a first passage length (L),

the second through hole (82) is in the shape of a cylinder whose cross-section intersecting perpendicularly to an axis direction of the cylinder has a second diameter (D2) and whose length in the axis direction is a second passage length (L), and

the first passage length and the second passage length are equal to each other, and the first diameter (D1) is smaller than the second diameter (D2) (D1<D2).

As shown in FIG. 4, when the passage length of the through hole having the shape of a cylinder is a fixed length (L), the smaller the diameter of the through hole becomes, the higher the flow velocity of the flame (fuel-air mixture under combustion) ejected from the ignition chamber to the main combustion chamber through the through hole becomes and, therefore, the larger the penetration of the flame becomes. Therefore, in accordance with the above-mentioned aspect, the “first through hole and second through hole” which can eject flames with mutually different magnitudes of penetration can be provided only by forming at least two through holes with mutually different diameters, while maintaining the passage lengths of the through holes at a fixed value by setting the thickness of regions of the partition wall part, in which the through holes are formed.

In another aspect of the present invention engine,

the first through hole (91) is in the shape of a cylinder whose cross-section intersecting perpendicularly to an axis direction of the cylinder has a first diameter (D1a) and whose length in the axis direction is a first passage length (L1a),

the second through hole (92) is in the shape of a cylinder whose cross-section intersecting perpendicularly to an axis direction of the cylinder has a second diameter (D2a) and whose length in the axis direction is a second passage length (L2a), and

said first diameter and said second diameter are equal to each other (D1a=D2a=D0), and said first passage length (L1a) is longer than said second passage length (L2a).

As shown in (A) of FIG. 7, in a case where the diameter of the through hole having the shape of a cylinder is a fixed size (D0), swirls generated as flame flows into the through hole continues to be generated until it reaches an opening of the through hole, which is opened to the main combustion chamber, when the passage length of the through hole is a small value (Lsmall). As a result, since the flame ejected from the through hole spreads, the penetration of the flame becomes small. On the contrary to this, as shown in (B) of FIG. 7, in a case where the diameter of the through hole having the shape of a cylinder is a fixed size (D0), swirls generated as a flame flows into the through hole attenuates or disappears before reaching the opening of the through hole, which is opened to the main combustion chamber, when the passage length of the through hole is a large value (Llarge>Lsmall). As a result, since the flame ejected from the through hole does not spread, the penetration of the flame becomes large. Consequently, in accordance with the above-mentioned another aspect, just by forming at least two through holes having a diameter equal to each other in regions having different thicknesses of the partition wall part, the “first through hole and second through hole” which can eject flames with mutually different magnitudes of penetration can be provided.

The internal combustion engine according to further another aspect of the present invention engine further comprises:

a fuel injection valve (60a) disposed on the cylinder head wall (41) such that an injection hole part (61a) for fuel Injection is exposed to the ignition chamber (CI), and

the internal combustion engine is configured such that the flame is generated by initiating combustion of fuel-air mixture which contains fuel injected from the injection hole part into the ignition chamber with a spark generated from the spark generation part (71a).

In accordance with this aspect, since fuel is directly injected into the ignition chamber, a “fuel-air mixture having an easily ignitable air-fuel ratio” can be easily formed inside the ignition chamber with less fuel. Therefore, even when an air-fuel ratio of a fuel-air mixture formed in the whole combustion chamber (the ignition chamber and the main combustion chamber) is increased, combustion can be generated stably and efficiency of the engine can be raised.

In the above-mentioned explanation, in order to help understanding of the present invention, names and/or reference signs used in embodiment which will be mentioned later are attached in parenthesis to constituents of the invention corresponding to the embodiments. However, constituents of the present invention are not limited to the embodiments specified with the above-mentioned names and/or the above-mentioned reference signs. Other objectives, other features and accompanying advantages of the present invention will be easily understood from the following explanation about embodiments of the present invention described referring to drawings.

### BRIEF DESCRIPTION OF DRAWINGS

FIG. 1 is a longitudinal section of the vicinity of a combustion chamber of an internal combustion engine according to a first embodiment of the present invention.

FIG. 2 is a sectional view of a cylinder of the internal combustion engine shown in FIG. 1 along a plane including the line 1-1 illustrated in FIG. 1.

FIG. 3 is an expanded sectional view of the partition wall part shown in FIG. 1 and FIG. 2.

FIG. 4 includes (A) and (B), and is a view for showing a flow of flame passing through a through hole formed in the partition wall part shown in FIG. 1 to FIG. 3.

FIG. 5 is a sectional view of a cylinder of an internal combustion engine according to a second embodiment of the present invention.

FIG. 6 is an expanded sectional view of the partition wall part shown in FIG. 5.

FIG. 7 includes (A) and (B), and is a view for showing a flow of flame passing through a through hole formed in the partition wall part shown in FIG. 5 and FIG. 6.

FIG. 8 includes (A) and (B), and is a view for showing a flow of flame passing through a through hole formed in a partition wall part of a first modification of the present invention.

FIG. 9 includes (A) and (B), and is a view for showing a flow of flame passing through a through hole formed in a partition wall part of a second modification of the present invention.

FIG. 10 is a sectional view of a cylinder of an internal combustion engine according to a third modification of the present invention.

FIG. 11 is an expanded sectional view of the partition wall part shown in FIG. 10.

FIG. 12 includes (A) and (B), and (A) is a longitudinal section of the vicinity of a combustion chamber of an internal combustion engine according to a fourth modification of the present invention, and (B) is a sectional view of a cylinder of the internal combustion engine shown in (A) along a plane including the line 2-2 illustrated in (A).

### DESCRIPTION OF EMBODIMENTS

Hereafter, an internal combustion engine (which will be referred to as an “engine” hereafter) according to each of embodiments of the present invention will be explained referring to drawings. These engines are multi-cylinder, reciprocating piston type, four-stroke cycle, gasoline fuel, spark ignition type engines.

### First Embodiment

### (Configuration)

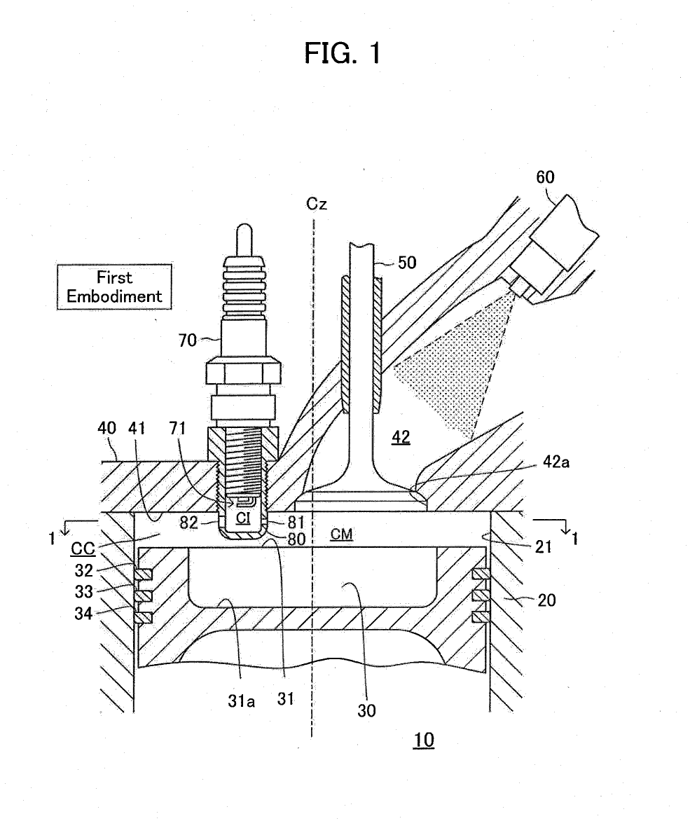

As shown in FIG. 1, an engine 10 according to a first embodiment of the present invention comprises a cylinder block 20, a piston 30, a cylinder head 40, an intake valve 50, a fuel injection valve 60, a spark plug 70 and a partition wall part (barrier) 80. Furthermore, the engine 10 comprises an exhaust valve which is not illustrated in FIG. 1. In addition, FIG. 1 is a longitudinal section of a specific cylinder, and other cylinders also have the same structure as the architecture shown in FIG. 1.

The cylinder block 20 comprises a cylinder bore wall 21. The cylinder bore wall 21 forms a cylinder bore in the shape of a cylinder. In addition, a cylinder liner may be attached to the cylinder bore. In that case, the cylinder liner also constitutes a part of the cylinder bore wall.

The piston 30 has an approximately columnar shape and is housed in the cylinder bore. A cavity 31a is formed in a part (which will be referred to as a “piston crown surface part” hereafter) 31 which constitutes a crown surface (upper surface) of the piston 30. Furthermore, three piston rings 32, 33 and 34 are attached to a side part of the piston crown surface part 31. The piston rings 32, 33 and 34 slide with respect to the cylinder bore wall 21, when the piston 30 reciprocates inside the cylinder bore.

The cylinder head 40 is disposed at the upper end of the cylinder block 20. The cylinder head 40 comprises a wall (which will be referred to as a “cylinder head wall” hereafter) 41 which blocks (obstructs) an upper opening of the cylinder bore. The cylinder head wall 41 defines a combustion chamber CC together with the piston crown surface part 31 and the cylinder bore wall 21.

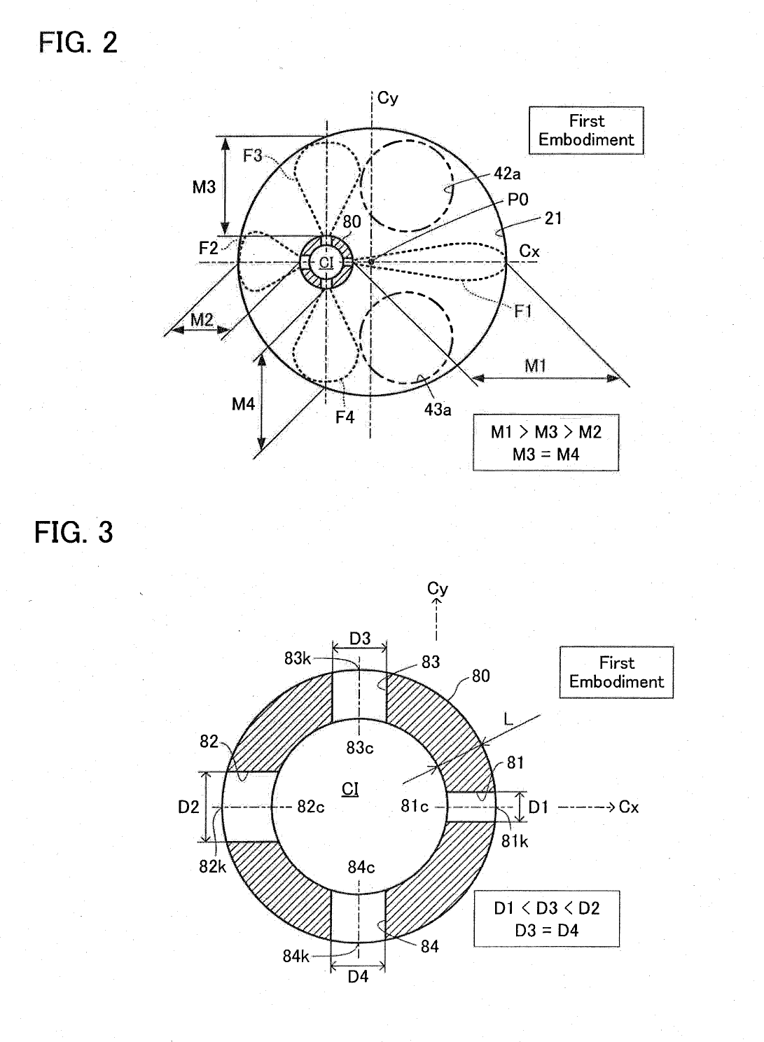

Furthermore, the cylinder head 40 forms an intake port 42. An end part of the intake port 42 is communicated to the combustion chamber CC at an air intake communication part 42a (refer to FIG. 1 and FIG. 2).

Similarly, the cylinder head 40 forms an exhaust port which is not illustrated. An end part of the exhaust port is communicated to the combustion chamber CC at an exhaust communication part 43a (refer to FIG. 2).

The air intake communication part 42a and the exhaust communication part 43a are disposed at positions linearly symmetrical with a first central line Cx passing through a central point P0 in a planar view (top view) of the combustion chamber CC, as shown in FIG. 2. Furthermore, in a planar view of the combustion chamber CC, a part of the air intake communication part 42a and a part of the exhaust communication part 43a intersect with a “second central line Cy which intersects perpendicularly to the first central line Cx and passes through the central point P0.”

Referring to FIG. 1 again, the intake valve 50 is configured to be driven by the intake cam disposed on an air intake cam shaft, which is not illustrated, to thereby open and close the air intake communication part 42a.

Similarly, the exhaust valve, which is not illustrated, is configured to be driven by an exhaust cam disposed on an air intake cam shaft, which is not illustrated, to thereby open and close the exhaust communication part 43a (refer to FIG. 2).

The fuel injection valve 60 is disposed in the cylinder head 40 such that fuel is injected into the intake port 42 towards the air intake communication part 42a. The fuel injection valve 60 responds to an instruction from ab electric control unit (ECU), which is not illustrated, to inject fuel.

The spark plug 70 has an approximately columnar shape, and is disposed in the cylinder head 40 such that its axis is parallel to a central axis Cz (axis Cz passing through the central point P0 shown in FIG. 2) of the cylinder bore. The spark plug 70 comprises a spark generation part (a center electrode and an earth electrode) 71 at the leading end (tip) (lower end of the spark plug 70 in FIG. 1). If a partition wall part 80, which will be mentioned later, does not exist, the spark plug 70 is disposed such that the spark generation part 71 is exposed to the combustion chamber CC. The spark plug 70 generates a spark for ignition from the spark generation part 71, when a high voltage is impressed to the spark generation part 71 based on an instruction from the electric control unit.

The partition wall part 80 is prepared in the cylinder head wall 41 so as to cover the spark generation part 71 of the spark plug 70 and to project from an upper wall part (namely, the cylinder head wall 41) of the combustion chamber CC into the combustion chamber CC. In other words, the partition wall part 80 partitions the combustion chamber CC into a main combustion chamber CM, to which the cylinder bore wall 21 and the piston crown surface part 31 is exposed, and an ignition chamber CI, to which the spark generation part 71 is exposed.

More specifically, the partition wall part 80 is constituted integrally with a covering of the spark plug 70. However, the partition wall part 80 may consist of a member separate from the covering of the spark plug 70. The partition wall part 80 has the shape of a cylinder whose upper surface (surface on the side of the cylinder head 40) is open and whose lower surface (surface on the side of the piston crown surface part 31) is blocked (shape of a cylinder with a bottom).

As expanded to be shown in FIG. 3, the partition wall part 80 comprises four (a plurality of) through holes (first to fourth through holes) 81 to 84. The shape of these through holes 81 to 84 is a cylindrical shape. Furthermore, the partition wall part 80 has a fixed thickness (wall thickness) L.

An axis (central axis) 81c of the first through hole 81 intersects perpendicularly to the central axis Cz of the cylinder bore and agrees with the first central line Cx in a planar view of the combustion chamber CC. The diameter (passage diameter) of the first through hole 81 is a length D1. The length (passage length) in the direction of the axis 81c of the first through hole 81 is a length L. A distance between a first opening 81k, which is an end on the side of the main combustion chamber CM of the first through hole 81, and a region of the cylinder bore wall 21, which is opposed to the first opening 81k(namely, a region of the cylinder bore wall 21 on the axis 81c which is a main ejection direction of flame from the first through hole 81) is a length M1 (refer to FIG. 2).

An axis (central axis) 82c of the second through hole 82 intersects perpendicularly to the central axis Cz of the cylinder bore and agrees with the first central line Cx in a planar view of the combustion chamber CC. The diameter (passage diameter) of the second through hole 82 is a length D2. The length (passage length) in the direction of the axis 81c of the second through hole 82 is a length L. A distance between a second opening 82k, which is an end on the side of the main combustion chamber CM of the second through hole 82, and a region of the cylinder bore wall 21, which is opposed to the second opening 82k (namely, a region of the cylinder bore wall 21 on the axis 82c which is a main ejection direction of flame from the second through hole 82) is a length M2 (refer to FIG. 2).

An axis (central axis) 83c of the third through hole 83 intersects perpendicularly to the central axis Cz of the cylinder bore and is parallel to the second central line Cy in a planar view of the combustion chamber CC. The diameter (passage diameter) of the third through hole 83 is a length D3. The length (passage length) in the direction of the axis 83c of the third through hole 83 is a length L. A distance between a third opening 83k, which is an end on the side of the main combustion chamber CM of the third through hole 83, and a region of the cylinder bore wall 21, which is opposed to the third opening 83k (namely, a region of the cylinder bore wall 21 on the axis 83c which is a main ejection direction of flame from the third through hole 83) is a length M3 (refer to FIG. 2).

An axis (central axis) 84c of the fourth through hole 84 intersects perpendicularly to the central axis Cz of the cylinder bore and is parallel to the second central line Cy in a planar view of the combustion chamber CC. The diameter (passage diameter) of the fourth through hole 84 is a length D4. The length (passage length) in the direction of the axis 84c of the fourth through hole 84 is a length L. A distance between a fourth opening 84k, which is an end on the side of the main combustion chamber CM of the fourth through hole 84, and a region of the cylinder bore wall 21, which is opposed to the fourth opening 84k (namely, a region of the cylinder bore wall 21 on the axis 84c which is a main ejection direction of flame from the fourth through hole 84) is a length M4 (refer to FIG. 2).

In addition, each of the axis 81c and the axis 84c may incline at a minute angle toward the piston crown surface part 31 with respect to a plane which intersects perpendicularly to the central axis Cz of the cylinder bore.

The partition wall part 80 cannot disposed at the center of combustion chamber CC in planar view due to the size and arrangement position, etc. of the air intake communication part 42a and the exhaust communication part 43a. Therefore, the partition wall part 80 is formed such that the following formula (1) is satisfied, regarding the “distances M1 to M4 between the openings on the side of the main combustion chamber CM of the respective through holes and the regions of the cylinder bore wall 21, which is opposed to the openings (namely, distances between the openings of respective through holes and the cylinder bore wall 21).”

M1>M3=M4>M2 (1)

Furthermore, the partition wall part 80 is formed such that the following formula (2) is satisfied, regarding the diameters D1 to D4 of the plurality of the through holes.

D1<D3=D4<D2 (2)

Namely, the passage lengths of the plurality of the through holes 81 to 84 are equal to one another and equal to the length L.

Among the plurality of the through holes 81 to 84, the through hole with the longest distance from the opening, which is opened to the main combustion chamber CM, to the region of the cylinder bore wall 21, which is opposed to the opening, is the first through hole 81, and the diameter D1 of the first through hole 81 is the smallest among the diameters D1 to D4 of the plurality of the through holes 81 to 84.

Among the plurality of the through holes 81 to 84, the through hole with the shortest distance from the opening, which is opened to the main combustion chamber CM, to the region of the cylinder bore wall 21, which is opposed to the opening, is the second through hole 82, and the diameter D2 of the second through hole 82 is the largest among the diameters D1 to D4 of the plurality of the through holes 81 to 84.

Furthermore, the distance M3 from the opening (83k) of the third through hole 83, which is opened to the main combustion chamber CM, to the region of the cylinder bore wall 21, which is opposed to the opening, is equal to the distance M4 from the opening (84k) of the fourth through hole 84, which is opened to the main combustion chamber CM, to the region of the cylinder bore wall 21, which is opposed to the opening, is shorter than the distance M1, and is longer than the distance M2. In addition, the diameter D3 of the third through hole 83 and the diameter D4 of the fourth through hole 84 are equal to each other, are larger than the diameter D1 of the first through hole 81, and smaller than the diameter D2 of the second through hole 82.

Thus, all of the plurality of the through holes (81 to 84) formed in the partition wall part 80 have the same passage length of the length L as one another, and the longer the distances between the openings (81k to 84k) which are the ends on the side of the main combustion chamber CM and the regions of the cylinder bore wall 21, which are opposed to the openings, are, the smaller the diameters are.

### (Operation)

In the engine 10, fuel is injected from the fuel injection valve 60 in an intake stroke. This fuel is inhaled into the main combustion chamber CM through the air intake communication part 42a together with air in the intake stroke. As a result, fuel-air mixture (gasoline mixture) is supplied into the main combustion chamber CM, and the fuel-air mixture is compressed in a compression stroke. At this time, the fuel-air mixture flows from the main combustion chamber CM into the ignition chamber CI through the first to fourth through holes 81 to 84. Thereafter, a spark for ignition is generated from the spark generation part 71 near the compressing top dead center. The fuel-air mixture in the ignition chamber CI is ignited by this spark for ignition, and combustion of the fuel-air mixture starts. Namely, flame is generated. Since pressure in the ignition chamber CI becomes higher by this combustion of the fuel-air mixture, the flames (the fuel-air mixture under combustion, i.e., hot gas) are ejected radially from the ignition chamber CI into the main combustion chamber CM through the first to fourth through holes 81 to 84. Large turbulence of air current is generated in the main combustion chamber CM by these ejected flames. Then, the fuel-air mixture which remains in the main combustion chamber CM is instantaneously ignited by the ejected flames and burns within a short time period.

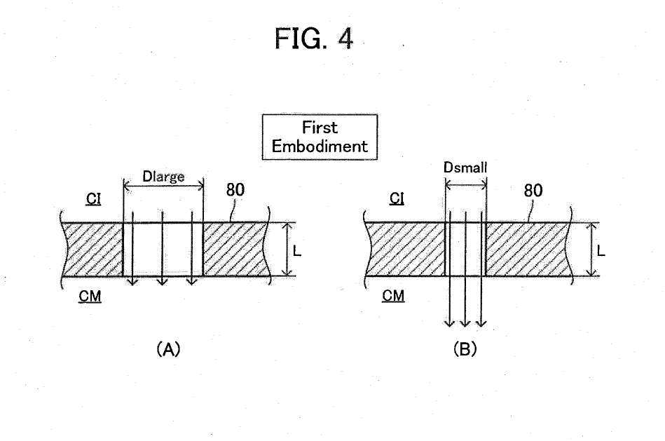

By the way, as shown in (A) of FIG. 4, in a case where the thickness of the partition wall part 80 (namely, passage length of the through hole) is the length L, the flow velocity of the flame (fuel-air mixture under combustion) which passes through the through hole is relatively low when the diameter of the through hole which has the shape of a cylinder type is a relatively large length Dlarge. Therefore, in this case, the penetration of the flame ejected through the through hole is relatively small (weak). It can also be said that penetration of flame is a distance where the flame can reach without losing the speed component in an ejection direction of the flame.

On the contrary to this, as shown in (B) of FIG. 4, in a case where the thickness of the partition wall part 80 (namely, passage length of the through hole) is the same length L as the thickness of the partition wall part 80 which is shown in (A) of FIG. 4, the flow velocity of the flame (fuel-air mixture under combustion) which passes through the through hole is relatively high when the diameter of the through hole which has the shape of a cylinder type is a relatively small length Dsmall (namely, Dsmall<Dlarge). Therefore, in this case, the penetration of the flame ejected through the through hole is relatively large. Thus, when the passage length of a through hole is the fixed value L, the smaller the diameter of the through hole is, the larger (stronger) the penetration of the flame ejected through the through hole is.

Based on such a viewpoint, the partition wall part 80 is formed such that the diameters D1 to D4 of the first to fourth through holes (81 to 84) satisfy the relation shown by the above-mentioned formula (2). Therefore, the penetration of the flame ejected from the first through hole 81 is larger than the penetrations of the flames ejected from other through holes (82 to 84). As a result, as shown in FIG. 2, flame Fl which is ejected from the first through hole 81 can reach the vicinity of the region of the cylinder bore wall 21, which is opposed to the opening 81k of the first through hole 81.

Furthermore, the penetration of the flame ejected from the second through hole 82 is smaller than the penetrations of the flames ejected from other through holes (81, 83, 84). As a result, as shown in FIG. 2, flame F2 which is ejected from the second through hole 82 can exactly reach the region of the cylinder bore wall 21, which is opposed to the opening 82k of the second through hole 82. In other words, the flame F2 will not collide with the cylinder bore wall 21 more than needed.

Furthermore, the penetration of the flame ejected from each of the third through hole 83 and the fourth through hole 84 is smaller than the penetration of the flame ejected from the first through hole 81 and larger than the penetration of the flame ejected from the second through hole 82. Therefore, as shown in FIG. 2, flame F3 which is ejected from the third through hole 83 can exactly reach the region of the cylinder bore wall 21, which is opposed to the opening 83k of the third through hole 83. In other words, the flame F3 will not collide with the cylinder bore wall 21 more than needed. Similarly, as shown in FIG. 2, flame F4 which is ejected from the fourth through hole 84 can exactly reach the region of the cylinder bore wall 21, which is opposed to the opening 84k of the fourth through hole 84. In other words, the flame F4 will not collide with the cylinder bore wall 21 more than needed.

As explained in the above, in the engine 10, the thickness of the wall of the partition wall part 80 is the fixed value L and thereby the passage length of each of the through holes is set to the length L, and the respective through holes are formed such that the longer the distance from the through hole (opening on the side of the main combustion chamber of the through hole) to the region of the cylinder bore wall 21, which is opposed to the opening of the through hole, is, the smaller the diameter of the through hole is. Therefore, since all the flames ejected from the respective through holes can reach the vicinity of the cylinder bore wall, knocking and poor combustion, etc., due to self-ignition will not occur in the main combustion chamber CM, and fuel-air mixture can be burned stably.

### Second Embodiment

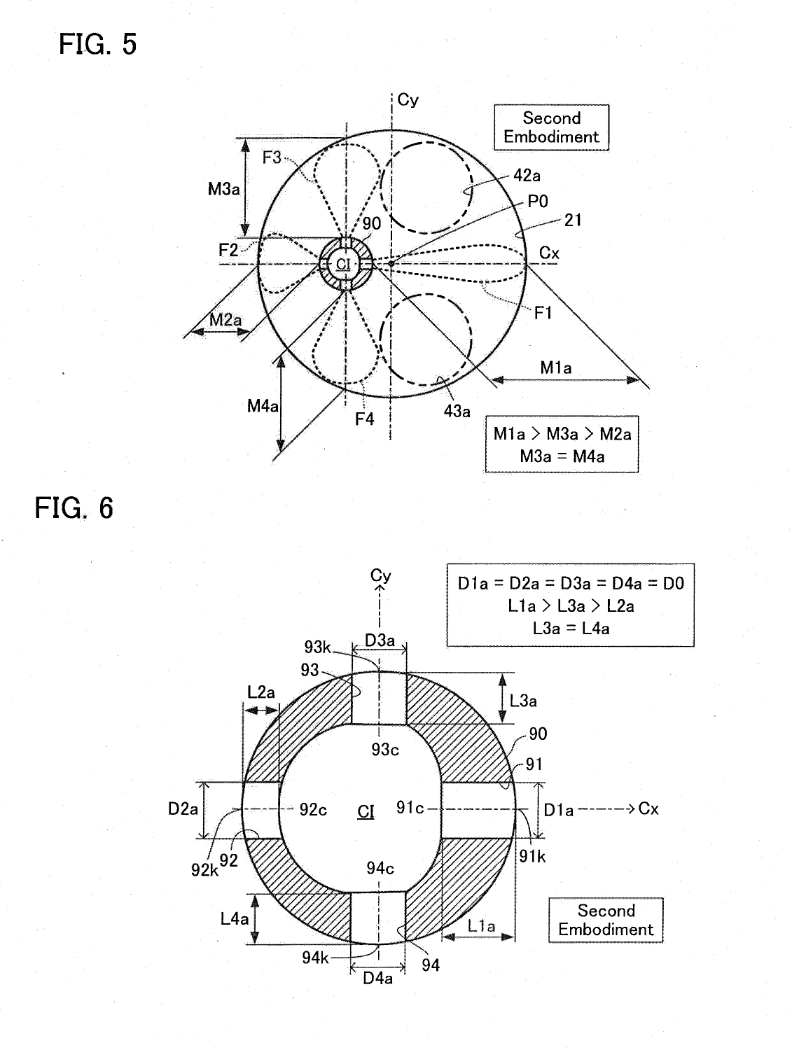

As shown in FIG. 5 and FIG. 6, an engine according to the second embodiment of the present invention is different from the engine 10 according to the first embodiment only in a point that the engine comprises a partition wall part 90 in place of the partition wall part 80 which the engine 10 according to the first embodiment comprises. More specifically, the thickness of the partition wall part 80 was the fix length L. On the contrary to this, the thickness of the partition wall part 90 changes (varies) in its circumferential direction. Furthermore, a plurality of through holes, which the partition wall part 90 comprises, has a diameter of the same length as one another. Hereafter, explanations will be added focusing on such differences.

The partition wall part 90 comprises four through holes (the first through hole 91, the second through hole 92, the third through hole 93, and the fourth through hole 94) like the partition wall part 80. The shape of these through holes 91 to 94 is cylindrical.

An axis (central axis) 91c of the first through hole 91 intersects perpendicularly to the central axis Cz of the cylinder bore and agrees with the first central line Cx in a planar view of the combustion chamber CC. The diameter (passage diameter) of the first through hole 91 is a length D1a. The length (passage length) in the direction of the axis 91c of the first through hole 91 is a length L1a. A distance between a first opening 91k, which is an end on the side of the main combustion chamber CM of the first through hole 91, and a region of the cylinder bore wall 21, which is opposed to the first opening 91k (namely, a region of the cylinder bore wall 21 on the axis 91c which is a main ejection direction of flame from the first through hole 91) is a length M1a (refer to FIG. 5).

An axis (central axis) 92c of the second through hole 92 intersects perpendicularly to the central axis Cz of the cylinder bore and agrees with the first central line Cx in a planar view of the combustion chamber CC. The diameter (passage diameter) of the second through hole 92 is a length D2a. The length (passage length) in the direction of the axis 91c of the second through hole 92 is a length L2a. A distance between a second opening 92k, which is an end on the side of the main combustion chamber CM of the second through hole 92, and a region of the cylinder bore wall 21, which is opposed to the second opening 92k (namely, a region of the cylinder bore wall 21 on the axis 92c which is a main ejection direction of flame from the second through hole 92) is a length M2a (refer to FIG. 5).

An axis (central axis) 93c of the third through hole 93 intersects perpendicularly to the central axis Cz of the cylinder bore and is parallel to the second central line Cy in a planar view of the combustion chamber CC. The diameter (passage diameter) of the third through hole 93 is a length D3a. The length (passage length) in the direction of the axis 93c of the third through hole 93 is a length L3a. A distance between a third opening 93k, which is an end on the side of the main combustion chamber CM of the third through hole 93, and a region of the cylinder bore wall 21, which is opposed to the third opening 93k (namely, a region of the cylinder bore wall 21 on the axis 93c which is a main ejection direction of flame from the third through hole 93) is a length M1a (refer to FIG. 5).

An axis (central axis) 94c of the fourth through hole 94 intersects perpendicularly to the central axis Cz of the cylinder bore and is parallel to the second central line Cy in a planar view of the combustion chamber CC. The diameter (passage diameter) of the fourth through hole 94 is a length D4a. The length (passage length) in the direction of the axis 94c of the fourth through hole 94 is a length L4a. A distance between a fourth opening 94k, which is an end on the side of the main combustion chamber CM of the fourth through hole 94, and a region of the cylinder bore wall 21, which is opposed to the fourth opening 94k (namely, a region of the cylinder bore wall 21 on the axis 94c which is a main ejection direction of flame from the fourth through hole 94) is a length M4a (refer to FIG. 5).

In addition, the axis 91c to the axis 94c may incline at a minute angle toward the piston crown surface part 31 with respect to a plane which intersects perpendicularly to the central axis Cz of the cylinder bore, similarly to the axis 81c and the axis 84c.

The partition wall part 90 is formed such that relations shown by the following formulae (3) to (5) are satisfied, regarding the distances M1a to M4a between the openings of the respective through holes and the cylinder bore wall 21, and lengths L1a to L4a in the axis directions of the respective through holes.

M1a>M3a=M4a>M2a (3)

D1a=D3a=D4a=D2a=D0 (4)

L1a>L3a=L4a>L2a (5)

Namely, the passage lengths of the plurality of the through holes 81 to 84 are equal to one another and equal to the length D0.

Among the plurality of the through holes 91 to 94, the through hole with the longest distance from the opening, which is opened to the main combustion chamber CM, to the region of the cylinder bore wall 21, which is opposed to the opening, is the first through hole 91, and the passage length Lia of the first through hole 91 is the longest among the passage lengths L1a to L4a of the plurality of the through holes 91 to 94.

Among the plurality of the through holes 91 to 94, the through hole with the shortest distance from the opening, which is opened to the main combustion chamber CM, to the region of the cylinder bore wall 21, which is opposed to the opening, is the second through hole 91, and the passage length L2a of the second through hole 92 is the shortest among the passage lengths L1a to L4a of the plurality of the through holes 91 to 94.

Furthermore, the distance M3a from the opening (93k) of the third through hole 93, which is opened to the main combustion chamber CM, to the region of the cylinder bore wall 21, which is opposed to the opening, is equal to the distance M4a from the opening (94k) of the fourth through hole 94, which is opened to the main combustion chamber CM, to the region of the cylinder bore wall 21, which is opposed to the opening, is shorter than the distance M1a, and is longer than the distance M2a. In addition, the passage length L3a of the third through hole 93 and the passage length L4a of the fourth through hole 94 are equal to each other, are shorter than the passage length L1a of the first through hole 91, and is longer than the passage length L2a of the second through hole 92.

Thus, all of the plurality of the through holes (91 to 94) formed in the partition wall part 90 have the same diameter D0 as one anther, and the longer the distances between the openings (91k to 94k) which are the ends on the side of the main combustion chamber CM and the regions of the cylinder bore wall 21, which are opposed to the openings, are, the larger the lengths in the axis direction (passage lengths) are.

### (Operation)

The engine according to the second embodiment operates similarly to the engine 10 according to the first embodiment. Namely, in a compression stroke, fuel-air mixture flows from the main combustion chamber CM into the ignition chamber CI, and the fuel-air mixture in the ignition chamber CI is ignited by a spark for ignition from the spark generation part 71 near the compressing top dead center. Therefore, combustion of the fuel-air mixture in the ignition chamber CI starts and flame is generated in the ignition chamber CI. This flame (the fuel-air mixture under combustion, i.e., hot gas) is ejected radially from the ignition chamber CI into the main combustion chamber CM through the first to fourth through holes 91 to 94. Large turbulence of air current is generated in the main combustion chamber CM by this ejected flame. Then, the fuel-air mixture which remains in the main combustion chamber CM is instantaneously ignited by the ejected flame, and burns within a short time period.

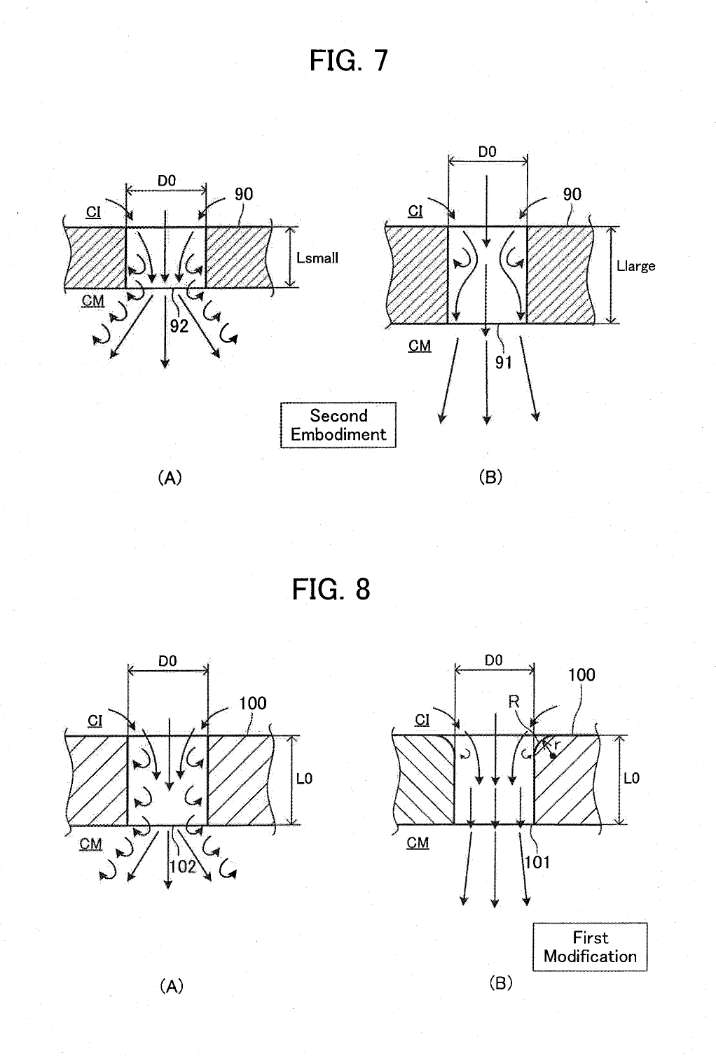

By the way, as shown in (A) of FIG. 7, in a case where the diameter of the through hole is the length D0 and the thickness of the partition wall part (namely, passage length of the through hole) is a relatively short length Lsmall, the flame (fuel-air mixture under combustion) which flows from the ignition chamber CI side into the through hole flows away from the surface of the wall surface of the through hole at the entrance of the through hole to generate swirls. Since the passage length of the through hole is short, these swirls of the flame reach the exit (opening on the side of the main combustion chamber CM) of the through hole. Therefore, the flame ejected from the exit of the through hole into the main combustion chamber CM spreads by the swirls. As a result, the penetration of the flame ejected through the through hole becomes small relatively.

On the contrary to this, as shown in (B) of FIG. 7, in a case where the diameter of the through hole is the length D0 and the thickness of the partition wall part (namely, passage length of the through hole) is a relatively long length Llarge, although the flame (fuel-air mixture under combustion) which flows from the ignition chamber CI side into the through hole flows away from the surface of the wall surface of the through hole at the entrance of the through hole, the swirls attenuate (disappear) before reaching the exit of the through hole since the passage length of the through hole is long. Therefore, the flame ejected from the exit of the through hole into the main combustion chamber CM will not spread. As a result of this, the penetration of the flame ejected through the through hole becomes large relatively.

Based on such a viewpoint, the partition wall part 90 is formed such that the diameters D1a to D4a of the first to fourth through holes (91 to 94) satisfy the relations shown by the above-mentioned formulae (4) and (5). Therefore, the penetration of the flame ejected from the first through hole 91 is larger than the penetrations of the flames ejected from other through holes (92 to 94). As a result, as shown in FIG. 5, flame F1 which is ejected from the first through hole 91 can reach the vicinity of the region of the cylinder bore wall 21, which is opposed to the opening 91k of the first through hole 91.

Furthermore, the penetration of the flame ejected from the second through hole 92 is smaller than the penetrations of the flames ejected from other through holes (91, 93, 94). As a result, as shown in FIG. 5, flame F2 which is ejected from the second through hole 92 can exactly reach the region of the cylinder bore wall 21, which is opposed to the opening 92k of the second through hole 92. In other words, the flame F2 will not collide with the cylinder bore wall 21 more than needed.

Furthermore, the penetration of the flame ejected from each of the third through hole 93 and the fourth through hole 94 is smaller than the penetration of the flame ejected from the first through hole 91 and larger than the penetration of the flame ejected from the second through hole 92. Therefore, as shown in FIG. 5, flames (F3, F4) ejected respectively from the third through hole 93 and the third through hole 94 can exactly reach the region of the cylinder bore wall 21, which is opposed to the openings (93k and 94k) of the respective through holes. In other words, the flames (F3 and F4) ejected respectively from the third through hole 93 and the third through hole 94 will not collide with the cylinder bore wall 21 more than needed.

As explained in the above, in the engine according to the second embodiment, the diameters of the through holes are set to a fixed value (length D0), and the respective through holes are formed such that the longer the distance from the through hole (opening on the side of the main combustion chamber of the through hole) to the region of the cylinder bore wall 21, which is opposed to the opening of the through hole, is, the longer the passage length of the through hole is. Therefore, since all the flames ejected from the respective through holes can reach the vicinity of the cylinder bore wall, knocking and poor combustion, etc., due to self-ignition will not occur in the main combustion chamber CM, and fuel-air mixture can be burned stably.

As explained in the above, since the internal combustion engines according to the respective embodiments of the present invention can appropriately set the penetration of the flame ejected from the ignition chamber to the main combustion chamber through the through hole in the partition wall part, fuel-air mixture can be burned stably in the main combustion chamber.

The present invention is not limited to the above-mentioned embodiments, and can adopt various modifications as described below within the scope of the present invention.

### (First Modification)

In order to strengthen the penetration of the flame ejected from the through hole, as shown in (B) of FIG. 8, the shape of the end on the side of the ignition chamber CI of the through hole (edge of the entrance side opening) may be a curved surface R. In accordance with this, the swirls generated a the flame (fuel-air mixture under combustion) which flows from the ignition chamber CI into the through hole flows into the through hole can be weakened as compared with the case where the edge on the entrance side opening is a right angle shape as shown in (A) of FIG. 8. Therefore, when the shape of the edge on the entrance side opening is a curved surface shape, the swirls of the flame attenuate (disappear) before reaching the exit of the through hole (opening on the side of the main combustion chamber CM). Therefore, the flame ejected from the exit of the through hole into the main combustion chamber CM will not spread. As a result, the penetration of the flame ejected through the through hole can be strengthened relatively.

In this case, the larger he radius r of the curved surface of the entrance side opening of the respective through holes are made, the relatively stronger the penetration of the flame ejected through the respective through holes can be made. Therefore, for example, in the partition wall part 80 of the first embodiment, what is necessary is just to set a radius r1 of a curved surface on the entrance side opening of the first through hole 81 to a largest value, set a radius r2 of a curved surface on the entrance side opening of the second through hole 82 to a smallest value, and set radii r3 and r4 of curved surfaces of the entrance side openings of the third through hole 83 and the fourth through hole 84 to intermediate values between the largest value and the smallest value. Furthermore, in this case, the diameters D1 to D4 may be set to the same length D0 as one another.

### (Second Modification)

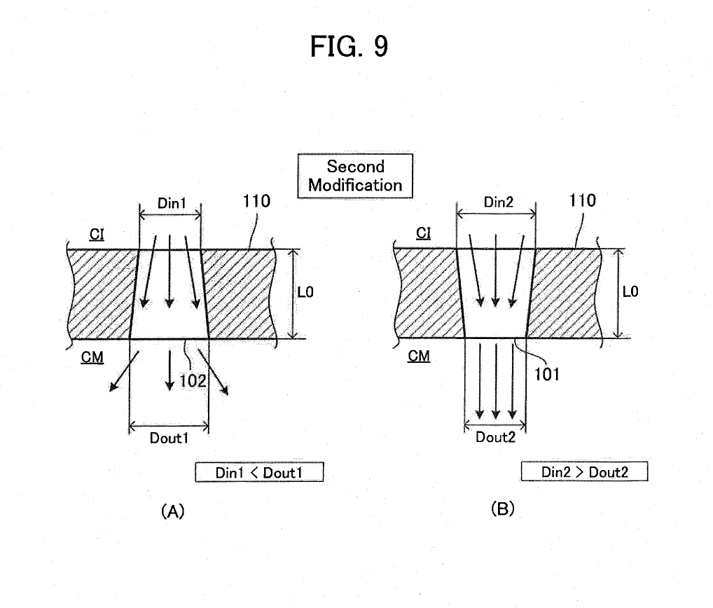

As shown in (A) and (B) of FIG. 9, in order to adjust the penetration of the flame ejected from the through hole, the diameter of the through hole may be changed in a direction from the ignition chamber CI toward the opening on the side of the main combustion chamber CM along the central axis.

More specifically, the diameter of the through hole shown in (A) of FIG. 9 is increasing from a value Din1 to a value Dout1 in the direction toward the opening on the side of the main combustion chamber CM along the central axis. As a result of this, since the flame ejected from the through hole shown in (A) of FIG. 9 spreads easily, its penetration is relatively small. On the contrary to this, the diameter of the through hole shown in (B) of FIG. 9 is decreasing from a value Din2 to a value Dout2 in the direction toward the opening on the side of the main combustion chamber CM along the central axis. As a result of this, since the flame ejected from the through hole shown in (B) of FIG. 9 goes straight on easily and the velocity of the flame which passes through the through hole becomes large, its penetration is relatively large. Therefore, for example, in the partition wall part 80 of the first embodiment, the shape of the first through hole 81 may be set to the shape shown in (B) of FIG. 9, the shape of the second through hole 82 may be set to the shape shown in (A) of FIG. 9, and the shape of the third through hole 83 and the fourth through hole and 84 may be set to the shape of a cylinder.

### (Third Modification)

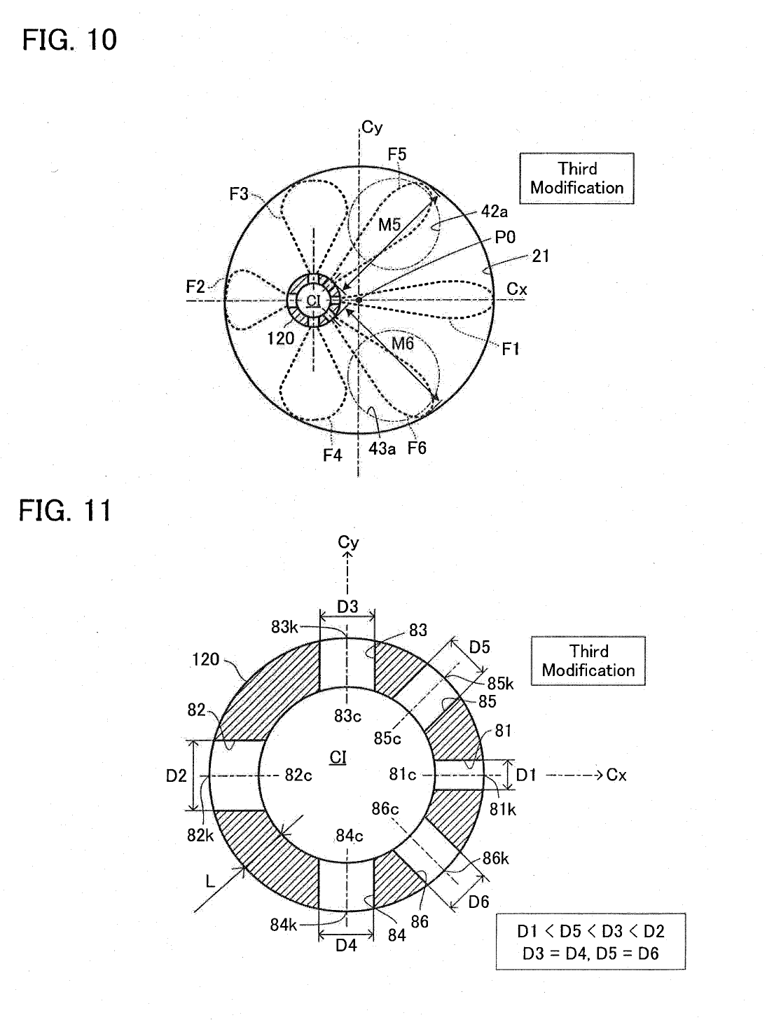

As shown in FIG. 10 and FIG. 11, the number of the through holes formed in the partition wall part is not limited to four. Namely, six through holes (81 to 86) are formed in a partition barrier 120 shown in FIG. 10 and FIG. 11. The partition barrier 120 has the same configuration as the partition wall part 80 except for the point that the fifth through hole 85 and the sixth through hole 86 are formed.

An axis (central axis) 85c of the fifth through hole 85 intersects perpendicularly to the central axis Cz of the cylinder bore and agrees with a “straight line which is parallel to a straight line obtained by rotating the first central line Cx 45 degrees counterclockwise and passes through the center in a planar view of the combustion chamber CC.” The diameter (passage diameter) of the fifth through hole 85 is a length D5. A distance between a fifth opening 85k, which is an end on the side of the main combustion chamber CM of the fifth through hole 85, and a region of the cylinder bore wall 21, which is opposed to the fifth opening 85k (namely, a region of the cylinder bore wall 21 on the axis 85c which is a main ejection direction of flame from the fifth through hole 85) is a length M5 (refer to FIG. 10).

An axis (central axis) 86c of the sixth through hole 86 intersects perpendicularly to the central axis Cz of the cylinder bore and agrees with a “straight line which is parallel to a straight line obtained by rotating the first central line Cx 45 degrees clockwise and passes through the center in a planar view of the combustion chamber CC.” The diameter (passage diameter) of the sixth through hole 86 is a length D6. A distance between a sixth opening 86k, which is an end on the side of the main combustion chamber CM of the sixth through hole 86, and a region of the cylinder bore wall 21, which is opposed to the sixth opening 86k (namely, a region of the cylinder bore wall 21 on the axis 86c which is a main ejection direction of flame from the sixth through hole 86) is a length M6 (refer to FIG. 10).

The partition wall part (partition barrier) 120 is formed such that the following formula (6) is satisfied and a relation shown by the following formula (6) is satisfied regarding the “distances M1 to M6 between the respective through holes and the regions of the cylinder bore wall 21, which is opposed to the openings on the side of the main combustion chamber CM of the respective through holes” and a relation shown by the following formula (7) is satisfied regarding the diameters D1 to D6 of the respective through holes. In addition, the passage length of these through holes (81 to 86) is the same length L as one another.

M1>M5=M6>M3=M4>M2 (6)

D1<D5=D6<D3=D4<D2 (7)

In accordance with this partition wall part 120, as shown in FIG. 10, flame can also reach regions where the flame cannot sufficiently reach by the partition wall part 80 (more specifically, a region just below the air intake communication part 42a and a region just below the exhaust communication part 43a) through the fifth and sixth through holes (85, 86). Furthermore, as can be understood from the above-mentioned formula (7), not only the penetration of the flames (F1 to F4) ejected from the first to fourth through holes (81 to 84), but also the penetration of the flames (F5, F6) ejected from the fifth and sixth through holes (85, 86) can be set appropriately. Namely, the flames (F5, F6) can exactly reach the regions of the cylinder bore wall 21. Therefore, in the main combustion chamber CM, more stable combustion of fuel-air mixture can be generated. In addition, the partition wall part 90 in the second embodiment may be modified so as to comprise the fifth and sixth through holes etc., as well, similarly to the partition wall part 120.

### (Fourth Modification)

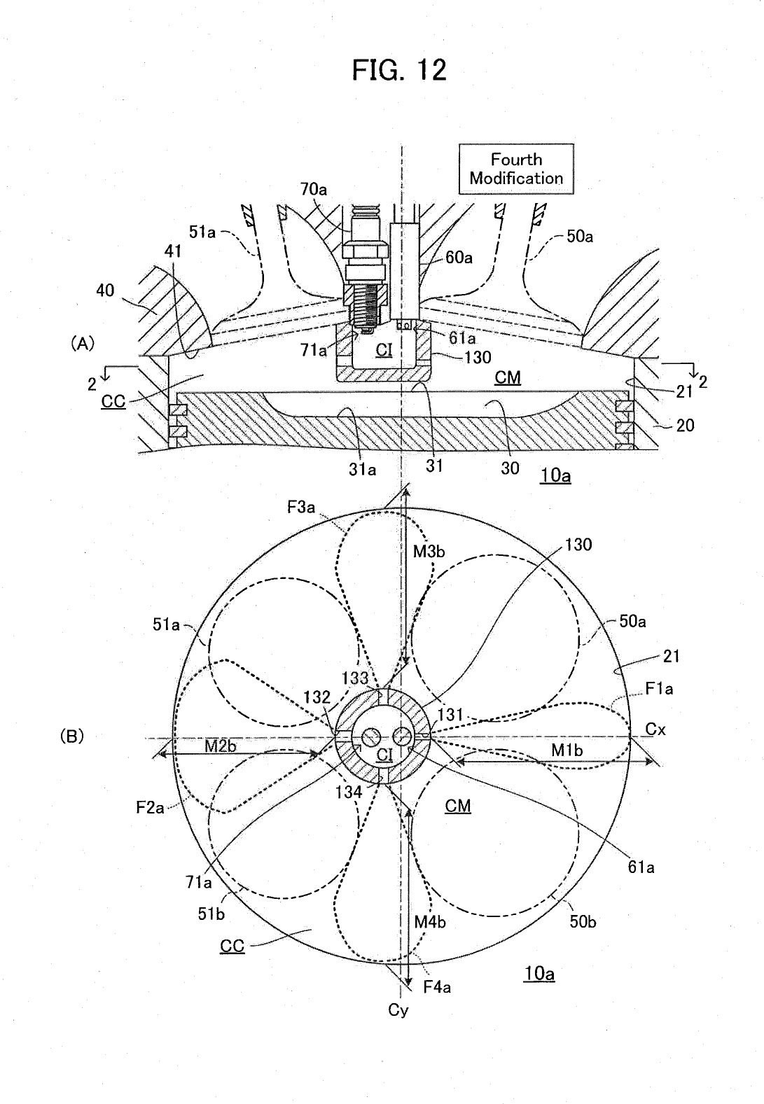

The internal combustion engine according to the present invention may be a 4 valve type internal combustion engine 10a as shown in FIG. 12. Namely, the engine 10a according to a fourth modification of the present invention shown in FIG. 12 comprises two intake valves 50a and 50b and two exhaust valves 51a and 51b for one combustion chamber CC. The combustion chamber CC of the engine 10a is what is called a pent roof type.

In the engine 10a, a spark plug 70a and a fuel injection valve 60a are fixed to the cylinder head 40 (cylinder head wall 41) in position near the center of the combustion chamber CC. If a partition wall part 130, which will be mentioned later, did not exist, a spark generation part 71a of the spark plug 70a and an injection hole part 61a for fuel Injection of the fuel injection valve 60a are disposed so as to be exposed to the combustion chamber CC.

The partition wall part 130 is formed in the cylinder head wall 41 so as to cover the spark generation part 71a and the injection hole part 61a and so as to project from an upper part of the combustion chamber CC (namely, the cylinder head wall 41) to the combustion chamber CC. The partition wall part 130 is arranged in a region surrounded by an air intake communication part where an intake valve 50a is opened and closed, an air intake communication part where an intake valve 50b is opened and closed, an exhaust communication part where an exhaust valve 51a is opened and closed, and an exhaust communication part where an exhaust valve 51b is opened and closed. The partition wall part 130 has the shape of a cylinder whose upper surface is open and whose lower surface is blocked (shape of a cylinder with a bottom). The center of the partition wall part 130 in a planar view is located on the exhaust communication part side (on the left side of the sheet in (B) of FIG. 12) rather than the center in a planar view of the cylinder bore. The partition wall part 130 partitions the combustion chamber CC into the main combustion chamber CM, to which the cylinder bore wall 21 and the piston crown surface part 31 are exposed, and the ignition chamber CI, to which the spark generation part 71a and the injection hole part 61a is exposed. The partition wall part 130 has a fixed thickness (wall thickness) L.

The partition wall part 130 has a first through hole 131, a second through hole 132, a third through hole 133 and a fourth through hole 134 corresponding respectively to the first through hole 81, the second through hole 82, the third through hole 83 and the fourth through hole 84 of the partition wall part 80. These through holes have the shape of a cylinder, and the passage length thereof is the same length L as one another. The orientation of the central axes of these through holes 131 to 134 is the same as those of the central axes of the through holes 81 to 84, respectively.

Among the plurality of the through holes 131 to 134, the through hole with the longest distance from the opening, which is opened to the main combustion chamber CM, to the region of the cylinder bore wall 21, which is opposed to the opening, is the first through hole 131. A distance between the opening (131k) of the first through hole 131, which is opened the main combustion chamber CM, and the cylinder bore wall 21, which is opposed to the opening, is a distance M1b.

Among the plurality of the through holes 131 to 134, the through hole with the shortest distance from the opening, which is opened to the main combustion chamber CM, to the region of the cylinder bore wall 21, which is opposed to the opening, is the second through hole 132. A distance between the opening (132k) of the second through hole 132, which is opened the main combustion chamber CM, and the cylinder bore wall 21, which is opposed to the opening, is a distance M2b.

A distance M3b from the opening (133k) of the third through hole 133, which is opened to the main combustion chamber CM, to the region of the cylinder bore wall 21, which is opposed to the opening, is equal to a distance M4b from the opening (134k) of the fourth through hole 134, which is opened to the main combustion chamber CM, to the region of the cylinder bore wall 21, which is opposed to the opening, is shorter than the distance M1b, and is longer than the distance M2b.

Furthermore, the partition wall part 130 is formed such that the following formula (8) is satisfied regarding a diameter D1b of the first through hole 131, a diameter D2b of the second through hole 132, a diameter D3b of the third through hole 133, a diameter D4b of the fourth through hole 134.

D1b<D3b=D4b<D2b (8)

In this engine 10a, much of the fuel injected from the fuel injection valve 60a at a predetermined timing remains inside the ignition chamber CI, and the remainder flows into the main combustion chamber CM through the through holes (131 to 134). Therefore, an air-fuel ratio of a fuel-air mixture in the ignition chamber CI becomes small relatively (namely, it becomes an air-fuel ratio which is easy to be ignited), and an air-fuel ratio of a fuel-air mixture in the main combustion chamber CM becomes large relatively. Thereafter, when a spark for ignition is generated in the spark generation part 71a, the fuel-air mixture in the ignition chamber CI is ignited by this spark for ignition, and combustion of the fuel-air mixture starts. Namely, flame is generated. Since pressure in the ignition chamber CI becomes higher by this combustion of the fuel-air mixture, the flame (the fuel-air mixture under combustion, i.e., hot gas) is ejected radially from the ignition chamber CI into the main combustion chamber CM through the first to fourth through holes 131 to 134. Large turbulence of air current is generated in the main combustion chamber CM by these ejected flames (F1a to F4a). Then, the fuel-air mixture in the main combustion chamber CM is instantaneously ignited by the ejected flames (F1a to F4a) and burns within a short time period.

Like this, in the engine 10a, since fuel is injected into the ignition chamber CI, a fuel-air mixture with good ignitability can be easily formed around the spark generation part 71a. Therefore, the fuel-air mixture can be stably ignited in the ignition chamber CI. Furthermore, since the through holes 131 to 134 are formed such that the above-mentioned formula (8) is satisfied, the flames (F1a to F4a) ejected from the respective through holes can reach the vicinity of the cylinder bore wall 21. As a result, knocking and poor combustion, etc., due to self-ignition will not occur in the main combustion chamber CM, and the fuel-air mixture can be burned stably. In addition, The engine 10a may comprise another fuel injection valve 60 separate from the fuel injection valve 60a, and may supply fuel to the combustion chamber CC from the fuel injection valve 60 together with the fuel injection valve 60a. Alternatively, the engine 10a may further comprise a cylinder injection valve which is a fuel injection valve separate from the fuel injection valve 60 and injects fuel directly into the main combustion chamber CM. Furthermore, the partition wall part 130 may have the same shape as the partition wall part 90.

### (Other Modifications)

In the engine 10 according to the above-mentioned first embodiment, the passage lengths of the plurality of the through holes were the same length L as one another and the diameters of the plurality of the through holes were different from one another (however, the diameter of the third through hole 83 and the fourth through hole 84 were the same as each other). Furthermore, in the engine according to the above-mentioned second embodiment, the diameters of the plurality of the through holes were the same length D0 as one another and the passage lengths of the plurality of the through holes were different from one another (however, the passage length of the third through hole 93 and the fourth through hole 94 were the same as each other). On the contrary to this, the passage length and diameter of each through hole may be different from the passage length and diameter of other through hole, respectively. Namely, the shape (dimension) of a through hole just has to be set such that penetration of flame ejected from the through hole becomes larger as a distance from an opening on the side of the main combustion chamber CM of the through hole to the region of the cylinder bore wall, which is opposed to the opening, becomes longer.

More specifically, the following relation A or relation B may be satisfied, since the degree of influence of the diameter of a through hole on penetration of flame is different from the degree of influence of the passage length of a through hole on the penetration of flame. In addition, in the relation A and the relation B, a diameter D1x is the diameter (first diameter) of the first through hole with a relatively long “distance from the opening on the side of the main combustion chamber CM of the through hole to the region of the cylinder bore wall 21, which is opposed to the opening” like the first through hole 81, for example, and the passage length L1x is the passage length of the first through hole (first passage length). Furthermore, in the relation A and the relation B, the diameter D2x is the diameter (second diameter) of the second through hole with a relatively short “distance from the opening on the side of the main combustion chamber CM of the through hole to the region of the cylinder bore wall 21, which is opposed to the opening” like the second through hole 82, for example, and the passage length L2x is the passage length of the second through hole (second passage length).

D1x>D2x, and

L1x>L2x, and

(L1x/D1x)>(L2x/D2x). (Relation A)

D1x<D2x, and

L1x<L2x, and

(L1x/D1x)>(L2x/D2x). (Relation B)

In addition, the above-mentioned relationship A can be reworded that the first through hole and the second through hole have a dimension (the diameter and passage length of the through hole) which makes the penetration of the flame ejected through the cylindrical first through hole is stronger than the penetration of the flame ejected through the cylindrical second through hole, the first passage length L1x is longer than the second passage length L2x, and the first diameter D1x is smaller than the second diameter D2x. In accordance with this, since a large quantity of flame (gas under combustion) whose penetration is relatively strong can be supplied to the region with a relatively long “distance from the opening on the side of the main combustion chamber CM of the through hole to the region of the cylinder bore wall 21, which is opposed to the opening”, the fuel-air mixture can be burned stably in the main combustion chamber. Furthermore, embodiments having either one of the first and second embodiments, the above-mentioned relation A and relation B may be combined with the first modification.

In addition, the partition wall part 80 may be formed such that the relation shown by the following formula (9) is satisfied. Namely, what is necessary is just that the penetration of the flame ejected through the first through hole 81 is larger than the penetration of the flame ejected through the second through hole 82, and the penetrations of the flames ejected through the third through hole 83 and the fourth through hole 84 may be comparable as the penetration of the flame ejected through the second through hole 82.

D1<D2=D3=D4 (9)

Similarly, the partition wall part 90 may be formed such that the relation shown by the following formula (10) is satisfied. Namely, what is necessary is to be just that the penetration of the flame ejected through the first through hole 91 is larger than the penetration of the flame ejected through the second through hole 92, and the penetrations of the flames ejected through the third through hole 93 and the fourth through hole 94 may be comparable as the penetration of the flame ejected through the second through hole 92.

L1a>L2a=L3a=L4a (10)

Furthermore, the shape of the through hole formed in the partition wall part may not necessarily be cylindrical, and the shape of the cross-section which intersects perpendicularly to the axis may be elliptical, oval and polygonal etc. Furthermore, although the partition wall part was in the shape of a cylinder with a bottom, whose cross-section intersecting perpendicularly to the axis was circular, it may be in the ape of a cylinder with a bottom, whose cross-section intersecting perpendicularly to the axis is oval and elliptical.

### REFERENCE SIGNS LIST

10 and 10a: Internal Combustion Engine, 20: Cylinder Block, 21: Cylinder Bore Wall, 30: Piston, 31: Piston Crown Surface Part, 40: Cylinder Head, 41: Cylinder Head Wall, 60 and 60a: Fuel Injection Valve, 61a: Injection Hole Part, 70 and 70a: Spark Plug, 71 and 71a: Spark Generation Part, 80, 90 and 130: Partition Wall Part, 81 to 84, 91 to 94 and 131 to 134: Through Hole.

1. An internal combustion engine comprising:
a spark plug which has a spark generation part, and
a partition wall part which partitions a combustion chamber into a main combustion chamber and an ignition chamber, said combustion chamber is defined by a cylinder bore wall, a piston crown surface part and a cylinder head wall, said cylinder bore wall and said piston crown surface part are exposed to said main combustion chamber, said spark generation part is exposed to said ignition chamber, and a plurality of through holes are formed in said partition wall part such that said main combustion chamber and said ignition chamber are in communication with each other, and
said internal combustion engine is configured such that flame is generated by initiating combustion of fuel-air mixture with a spark generated from said spark generation part in said ignition chamber and said flame is ejected from said ignition chamber to said main combustion chamber through the plurality of said through holes, wherein:
the plurality of said through holes in said partition wall part includes a first through hole and a second through hole,
a distance between a first opening that is an end of said first through hole on a side of said main combustion chamber and a region of said cylinder bore wall, which is opposed to the first opening, is equal to a first distance,
a distance between a second opening that is an end of said second through hole on a side of said main combustion chamber and a region of said cylinder bore wall, which is opposed to the second opening, is equal to a second distance which is shorter than said first distance, and
said first through hole and said second through hole are formed such that penetration of said flame ejected from said first through hole is larger than penetration of said flame ejected from said second through hole.

2. The internal combustion engine according to claim 1, wherein:
said first through hole is in the shape of a cylinder whose cross-section intersecting perpendicularly to an axis direction of the cylinder has a first diameter and whose length in said axis direction is a first passage length,
said second through hole is in the shape of a cylinder whose cross-section intersecting perpendicularly to an axis direction of the cylinder has a second diameter and whose length in said axis direction is a second passage length, and
said first passage length and said second passage length are equal to each other, and said first diameter is smaller than said second diameter.

3. The internal combustion engine according to claim 1, wherein:
said first through hole is in the shape of a cylinder whose cross-section intersecting perpendicularly to an axis direction of the cylinder has a first diameter and whose length in said axis direction is a first passage length,
said second through hole is in the shape of a cylinder whose cross-section intersecting perpendicularly to an axis direction of the cylinder has a second diameter and whose length in said axis direction is a second passage length, and
said first diameter and said second diameter are equal to each other, and said first passage length is longer than said second passage length.

4. The internal combustion engine according to claim 1, further comprising:
a fuel injection valve disposed on said cylinder head wall such that an injection hole part for fuel Injection is exposed to said ignition chamber, and
said internal combustion engine is configured such that said flame is generated by initiating combustion of fuel-air mixture which contains fuel injected from said injection hole part into said ignition chamber with a spark generated from said spark generation part.
